(19) United States
(12) Patent Application Publication
(10) Pub. No.: US 2004/0093193 A1
(43) Pub. Date: May 13, 2004

(54) System statistical associate

(75) Inventors: Brock Osborn, Niskayuna, NY (US); John Hershey, Ballston Lake, NY (US)

Correspondence Address: GENERAL ELECTRIC COMPANY, GLOBAL RESEARCH, PATENT DOCKET RM. BLDG. K1-4A59, SCHENECTADY, NY, 12301-0008, US

(73) Assignee: GENERAL ELECTRIC COMPANY, Schenectady, NY

(21) Appl. No.: 10/065,728

(22) Filed: Nov. 13, 2002

(51) Int. Cl. G06F 7/60; G06F 17/10

(52) U.S. Cl. 703/2

(57) ABSTRACT

An apparatus for and a method of analyzing system performance with a system statistical associate (SSA) is disclosed. The method includes collecting data on at least one system operating variable, discerning at least one parameter affecting system performance from the data, and generating a report on parameters affecting system performance.

### BACKGROUND OF THE INVENTION

The present invention relates generally to analyzing system performance with a system statistical associate (SSA).

System analysis tools have been developed to predict the reliability and efficiency associated with complex systems. One such system analysis tool is described in copending U.S. application Ser. No. 09/897,556 filed on Au. 3, 2001 by Carl H. Hanson et. al. entitled “Interactive Graphics-Based Analysis Tool For Visualizing Reliability Of A System And Performing Reliability Analysis Thereon”, which is incorporated by reference herein in its entirety.

Performing a reliability or operating efficiency analysis on a product or system can include a number of different analyses that determine how reliable or efficient the product or system is. As more companies become concerned with the servicing of their products and systems, for example, it becomes necessary to have an understanding of the reliability of the products and systems. This becomes even more necessary for complex systems such as locomotives, aircraft engines, automobiles, turbines, computers, appliances, transformer farms, etc., where there are many subsystems each having hundreds of replaceable units or components. If there is an understanding of the reliability of the systems, then future failures can likely be anticipated and any downtime associated with correcting the failures can likely be kept to a minimum. Furthermore, this understanding will allow a company to make design changes and corrections to systems and components in order to improve reliability.

Currently, there are several software packages that allow system engineers to perform reliability analyses of a system. However, these packages do have their disadvantages. For example, in many cases, subsets of data associated with the systems being analyzed must be “copied and pasted” into the software package and various tools within the package must be used to modify the data before it can be properly analyzed. Some tools allow the user to construct block diagrams of the system and enter parametric values for the reliability of each component of the block diagram. These software tools then allow the user to obtain system level reliability based on a roll-up of the components in the block diagram, utilizing either analytical or simulation based methods.

In many applications, however, critical parameters which directly affect the system performance are unknown. For example, the engineers may suspect that excessive heat is causing early failure of a particular machine, which is actually due to excessive vibrations being transferred from a nearby press. Known statistical associates would be unable to predict the failure, however, because prior knowledge of the parameters being examined is required.

### BRIEF SUMMARY OF THE INVENTION

According to one embodiment of the present invention, a method of analyzing system performance with a system statistical associate (SSA) is provided. The method includes collecting data on at least one system operating variable, discerning at least one parameter affecting system performance from the data, and generating a report on parameters affecting system performance.

According to another embodiment of the present invention, a system statistical associate (SSA) module for use in a SSA monitoring system is provided. The SSA module includes a sensor configured to sense at least one operating variable on a monitored device, a data processor configured to discern at least one parameter affecting the performance of the monitored device from the sensed operating variable (s), and a transmitter configured to transmit a data profile including the discerned parameter to a SSA system monitor.

According to another embodiment of the present invention, a system statistical associate (SSA) is provided. The SSA includes a plurality of SSA modules, and a SSA computer programmed to derive at least one system model based on data profiles received from the plurality of SSA modules. Each SSA module includes a sensor configured to sense at least one operating variable of a piece of equipment, and a module computer coupled to the sensor. The module computer of each SSA module is programmed to discern a parameter affecting equipment performance from the operating variable, create a data profile of parameters determined to affect equipment performance, and communicate the data profile to the SSA.

According to another embodiment of the present invention, a system statistical associate (SSA) is provided. The SSA includes means for generating data profiles of a plurality of monitored devices, means for discerning at least one parameter affecting system performance from the data profiles, and at least one of means for reporting the discerned parameter, and means for automatically changing the discerned parameter to improve system performance.

### BRIEF DESCRIPTION OF THE DRAWINGS

FIG. 1 is a block diagram of a plurality of system statistical associates (SSA) according to an embodiment of the present invention.

FIG. 2 is a flow chart of a method of analyzing system performance with a SSA according to an embodiment of the present invention.

### DETAILED DESCRIPTION OF THE INVENTION

Reference will now be made in detail to presently preferred embodiments of the present invention. Wherever possible, the same reference numbers will be used throughout the drawings to refer to the same or like parts.

For purposes of illustration, the following description of preferred embodiments of the present invention will be set forth in view of one or more monitored piece(s) of equipment. It should be appreciated that the term “equipment” may include, but is not limited to, locomotives, aircraft engines, automobiles, turbines, computers, appliances, transformer farms, or any other device or system capable of being monitored. Similarly, the following description describes monitoring operating variables of the aforementioned monitored equipment, which may include, for example, temperature, load, humidity, vibration, power expended, etc. Other monitored operating variables are also plausible, as would be readily apparent to one of ordinary skill in the art after reading this disclosure.

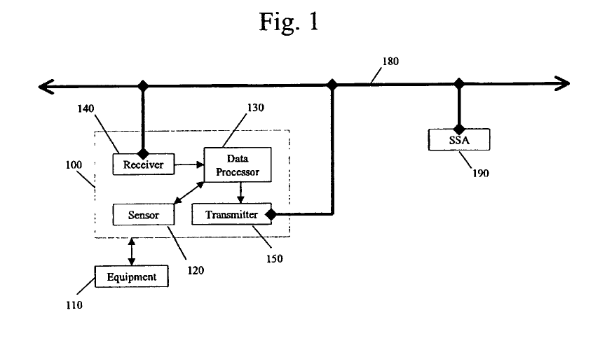

A system statistical associate (SSA) 100 according to a first embodiment of the present invention is shown in the block diagram of FIG. 1. The SSA 100 is but one of a plurality of SSAs 190 communicating with one another (or with a central monitor not shown) via communication medium 180 (e.g., a wireless LAN, a network, etc.). An individual SSA 100 is shown in detail in FIG. 1 and will be described in greater detail below, though it should be appreciated that the other SSAs 190 in the system preferably have similar configurations.

The SSA 100 is mounted on or near one or more pieces of equipment 110, and includes a sensor 120 configured to sense at least one operating variable relating to the equipment 110. The sensor 120 forwards sensed data on the operating variable to a data processor 130 for analyzing the data. The data processor 130 may comprise a special purpose processor chip such as an application specific integrated circuit (ASIC), a computer, or any other suitable data processing device. Data analysis will be described separately in greater detail below. After analyzing the data, the data processor 130 transmits the analyzed data to a central SSA system monitor (not shown) and/or other SSAs 190 using transmitter 150. The data processor 130 may also receive data profiles from other SSAs 190 via receiver 140 which can be used to supplement the data analysis performed by data processor 130.

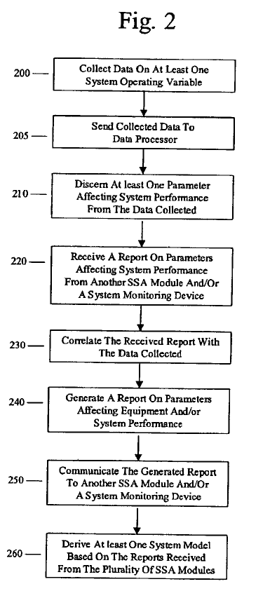

Operation of the aforementioned SSA 100 (i.e., by a given SSA module) according to an embodiment of the present invention will now be described in reference to the flowchart depicted in FIG. 2. In step 200, the sensor 120 collects data on at least one system operating variable (e.g., at least one operating variable on the equipment 110).

It should be appreciated that collecting data in step 200 may include an aggregate collection of data over time, where the data is stored in a database accessible by the data processor 130. Alternatively or in combination with stored data, step 200 may include instantaneous data collection where the data is analyzed dynamically as it is collected. The collected data is sent to data processor 130 in step 205 via a data link (e.g., a wireless LAN, a data bus, etc.).

In step 210, the data processor 130 discerns at least one parameter affecting system performance from the data collected by the sensor 120. In other words, step 210 preferably actively discerns at least one parameter which was previously unknown or unconfirmed. Thus, for example, if the operating temperature of the equipment 110 is being monitored to prevent the operating temperature to rise above a maximum allowed operating temperature, the data processor 130 in step 210 may discern that an operating temperature below the maximum allowed operating temperature can still lead to accelerated equipment 110 failure. In such a situation, the data processor 130 can be said to have discerned a new parameter affecting system performance, even though this parameter was previously being monitored for some other reason. Hence, it should be appreciated that the term “discern” requires more than monitoring of a predetermined operating variable.

Similarly, a combination of two or more operating parameters may be monitored where the data processor 130 discerns a parameter affecting system performance in step 210 based on a combination of the plurality of operating parameters. For example, the equipment 110 vibration and run time operating parameters may be monitored in step 200, such that the data processor 130 discerns equipment failure predictability when the equipment 110 of a certain time since last maintenance is undergoing a specific amount of vibration. Other combinations are also plausible, as would be readily apparent to one of ordinary skill in the art after reading this disclosure.

In step 220, a report on parameters affecting system performance may be received via receiver 140 from another SSA module 190 and/or from a system monitoring device. The received report can then be correlated in step 230 with the data collected in step 200 to supplement the data analysis performed by data processor 130 in step 210. Similarly, in step 250 the SSA module 190 may transmit a report on parameters affecting system performance via transmitter 150 to another SSA module 190 and/or to a system monitoring device, such as a SSA computer. By way of example, if two similar pieces of equipment 110 are being monitored by SSA modules 100 and 190, the SSA modules 100 and 190 may share information between themselves to supplement the data of each other. Using a previously described example, if the SSA module 190 determines that an operating temperature below the maximum allowed operating temperature can still lead to accelerated equipment failure, it can notify the SSA module 100 of this condition so that the equipment 110 can be monitored and controlled to prevent or predict such a failure. In this manner, the overall system performance can be improved by collective data analysis and sharing amongst the various SSA modules 100, 190.

According to one embodiment of the present invention, a data profile from the SSA module 100 is correlated in step 230 with the “nearest” SSA module(s) 190. By way of example, the nearest SSA module may be the SSA module having the closest equipment operating variables, the closest geographical proximity of equipment, the closest concurrent equipment operation, the closest specie (i.e., type) of equipment, the closest in time of equipment usage, etc. to that of equipment 110. In other words, the data profiles from the nearest or most similar conditions of interest are correlated to supplement the data analysis performed by data processor 130 in step 210.

In step 240, the data processor 130 generates a report on parameter(s) affecting equipment and/or system performance. Such a report may include, for example, a data profile on the equipment 110 monitored by the SSA 100, a data profile on similar pieces of equipment monitored by a plurality of SSAs 110, 190 including equipment 110, and/or a data profile on the entire system including a plurality of diverse and distinct pieces of equipment.

Preferably, the report generated in step 240 is used by the data processor 130 (or a system performance monitor) to derive at least one system model in step 260. Such a system model may include, for example, a system lifetime model, a system efficiency model, a system productivity model, an environmental model, an automotive maintenance model/warranty model, etc. Similarly, the report generated in step 240 can be used by the data processor to find correlation models among a plurality of monitored devices, data mine data profiles from each SSA, and/or perform known pattern recognition techniques on the data profiles from each SSA.

Once the system model is derived in step 260, the system model may be reported to appropriate personnel to take corrective action. Such personnel may include, for example, a maintenance team tasked to perform maintenance on equipment in a manufacturing plant. Alternatively, the system model may be used to automatically change the discerned parameter to improve system performance. By way of example, the operating speed of a piece of equipment may be slowed down if excessive vibration is detected and determined to degrade system performance. Other implementations of the system model are also plausible, as would be readily apparent to one of ordinary skill in the art after reading this disclosure.

As described above, the present invention allows for improved system performance modeling and for improved system reliability by providing risk analytics at the customer, for the customer. Moreover, the system can discern problems without necessarily having parameter to performance relationships predetermined.

The foregoing description of preferred embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principles of the invention and its practical application to enable one skilled in the art to utilize the invention in various embodiments and with various modifications as are suited to the particular use contemplated. It is intended that the scope of the invention be defined by the claims appended hereto, and their equivalents.

What is claimed is:

1. A method of analyzing system performance with a system statistical associate (SSA), the method comprising:
collecting data on at least one system operating variable;
discerning at least one parameter affecting system performance from the data; and
generating a report on the at least one parameter affecting system performance.

2. The method of claim 1, further comprising:
monitoring a plurality of devices with a corresponding number of SSA modules comprised of:
collecting data on at least one device operating variable;
discerning at least one parameter affecting device performance from the data;
generating a data profile of parameters affecting device performance; and
communicating the data profile from each SSA module to the SSA; and
deriving at least one system model based on data profiles received from the plurality of SSA modules.

3. The method of claim 2, further comprising:
correlating a data profile from a first SSA module with a data profile of a second SSA module.

4. The method of claim 3, wherein the second SSA module is the nearest SSA module to the first SSA module.

5. The method of claim 4, wherein the nearest SSA module comprises the SSA module with one of:
the closest device operating variables;
the closest geographical proximity of devices;
the closest concurrent device operation;
the closest specie of device; and
the closest in time of device usage.

6. The method of claim 2, further comprising at least one of:
deriving a system lifetime model from the data profile;
finding correlation models among the plurality of devices;
data mining the data profile from each SSA module; and
performing pattern recognition techniques on the data profile from each SSA module.

7. The method of claim 1, wherein an operating variable comprises one of temperature, load, humidity, vibration, and power expended.

8. The method of claim 1, further comprising:
automatically changing the at least one discerned parameter to improve system performance.

9. A system statistical associate (SSA) module for use in a SSA monitoring system, the SSA module comprising:
a sensor configured to sense at least one operating variable on a monitored device;
a data processor configured to discern at least one parameter affecting the performance of the monitored device from the at least one sensed operating variable; and
a transmitter configured to transmit a data profile including the discerned parameter to a SSA system monitor.

10. The SSA module of claim 9, further comprising:
a receiver configured to receive a data profile from another SSA module, wherein the data processor is further configured to correlate the received data profile with the sensed operating variable(s).

11. The SSA module of claim 10, wherein the received data profile is generated by another SSA module which comprises one of:
the closest in equipment operating variables;
the closest in geographical proximity of equipment;
the closest in concurrent equipment operation;
the closest in specie of equipment; and
the closest in time of equipment usage.

12. The SSA module of claim 9, wherein an operating variable comprises one of temperature, load, humidity, vibration, and power expended.

13. A system statistical associate (SSA), comprising:
a plurality of SSA modules, each SSA module comprised of:
a sensor configured to sense at least one operating variable of a piece of equipment; and
a module computer coupled to the sensor,
wherein the module computer is programmed to:
discern a parameter affecting equipment performance from the operating variable;
create a data profile of parameters determined to affect equipment performance; and
communicate the data profile to the SSA; and
a SSA computer programmed to derive at least one system model based on data profiles received from the plurality of SSA modules.

14. The SSA of claim 13, wherein the SSA computer is further programmed to correlate a data profile from a first SSA module with a data profile of a second SSA module.

15. The SSA of claim 14, wherein the nearest SSA module comprises the SSA module with one of:
the closest in equipment operating variables;
the closest in geographical proximity of equipment;
the closest in concurrent operation of equipment;
the closest in specie of equipment; and
the closest in time of use of equipment.

16. The SSA of claim 13, wherein the SSA computer is further programmed to derive a system lifetime model from the data profiles received from the plurality of SSA modules.

17. The SSA of claim 13, wherein an operating variable comprises one of temperature, load, humidity, vibration, and power expended.

18. The SSA of claim 13, wherein the SSA computer is further programmed to automatically change the discerned parameter to improve system performance.

19. A system statistical associate (SSA), comprising:
means for generating data profiles of a plurality of monitored devices;
means for discerning at least one parameter affecting system performance from the data profiles; and
at least one of:
means for reporting the discerned parameter; and
means for automatically changing the discerned parameter to improve system performance.

20. The SSA of claim 19, further comprising:
means for correlating the data profiles of at least two different monitored devices.

21. The SSA of claim 19, further comprising:
means for collecting data on at least one system operating variable.
